(19) United States
(12) Patent Application Publication
(10) Pub. No.: US 2006/0046939 A1
(43) Pub. Date: Mar. 2, 2006

(54) Alcohol acidizing composition for treating a well to increase production

(75) Inventor: Shaun T. Mesher, Calgary (CA)

Correspondence Address: THOMPSON LAMBERT;SUITE 703D, CRYSTAL PARK TWO, 2121 CRYSTAL DRIVE, ARLINGTON, VA, 22202, US

(73) Assignee: SynOil Fluids, Calgary (CA)

(21) Appl. No.: 11/055,488

(22) Filed: Feb. 11, 2005

(30) Foreign Application Priority Data
Sep. 1, 2004 (CA) 2,479,402

(51) Int. Cl. C09K 8/72; C09K 8/60

(52) U.S. Cl. 507/240

(57) ABSTRACT

An alcohol acidizing system for use in acidizing and cleanup in oil wells and gas wells. The system comprises an aqueous acid, such as hydrochloric acid, and at least one of an alkyl alcohol, such as methanol, ethyl alcohol, iso-propanol or the like, or any mixture thereof, an acetylenic alcohol such as methyl butynol, methyl pentynol, hexynol, ethyl octynol, propargyl alcohol, benzylbutynol, ethynylcyclohexanol, or the like, and an acetylenic diol, such as an alkoxylated acetylenic diol. The system may also contain water.

### BACKGROUND OF THE INVENTION

Paraffinic and asphaltenic hydrocarbons, as well as calcium carbonate and clays, may form undesirable deposits in boreholes and equipment used for the production of oil and gas from underground formations. The problem of removing such deposits is discussed in U.S. Pat. No. 4,498,997, U.S. Pat. No. 5,152,907, U.S. Pat. No. 5,366,643, U.S. Pat. No. 5,441,929, U.S. Pat. No. 5,697,443, and U.S. Pat. No. 6,242,388, and typically involves using an aqueous solution of an acid, such as hydrochloric acid, hydrofluoric acid, acetic acid, and the like, and mixtures thereof, in combination with a mutual solvent of oil and water. A challenge in the art of acidizing wells is to provide a system that is effective in cleaning wells and production equipment, while being economical and environmentally friendly.

### SUMMARY OF THE INVENTION

There is provided a system and method for use in acidizing and cleanup in oil wells and gas wells. According to an aspect of the invention, there is provided an alcohol acidizing composition for treating a well to increase the production of desired materials therefrom, the alchohol acidizing composition being formed from an aqueous acid solution including an aqueous acid and, based on the total weight of the aqueous acid solution, at least 1% by weight of at least one of an acetylenic alcohol, an acetylenic diol, and an alkyl alcohol. The system may comprise a combination of alcohols including: an acetylenic alcohol at 0-5% by weight, a diol at 0-5% by weight, and an alkyl alcohol at 0-49% by weight of the total acid solution. The system may also contain water at 0-20% by weight. A preferred alkyl alcohol is methanol. A preferred acetylenic alcohol is methyl butynol (0-5% by weight) and a preferred diol is an alkoxylated acetylenic diol, such as any of a number of diols sold under the trade name Surfynol® (0-5% by weight), supplied by Air Products and Chemicals Inc. of Allentown, Pa. The alcohol acidizing composition is injected into a well to treat the well.

Further summary of the invention is found in the claims, which are incorporated by reference here.

### DETAILED DESCRIPTION OF PREFERRED EMBODIMENTS OF THE INVENTION

The term “comprising” is used in its inclusive sense, and does not exclude other components being present. The term “water soluble” means substantially water soluble. All percentages used herein are weight percent of the total weight of the acetylenic acid, the acetylenic diol, the alkyl alcohol, and water in the acidizing solution. In the claims, where a component is said to be present in an amount from or between 0% and X %, then the component is present in some amount greater than, but not equal to, 0%.

The preferred components for this alcohol acidizing system for use in oil and gas well operations are an aqueous acid solution including, based on the total weight of the solution, at least 1% by weight of at least one of an acetylenic alcohol, an acetylenic diol, and an alkyl alcohol. The aqueous acid solution in a preferred embodiment is 15% hydrochloric acid, but other water soluble inorganic and organic acids in different concentrations may be used for the aqueous acid. The system may also contain water. The composition is used by injection into a well or production equipment.

The alkyl alcohol in a preferred embodiment is methanol, but ethyl alcohol, isopropanol and the like may also be used. The alkyl alcohol may be present in the amount of from 0% to 49% by weight in the alcohol acidizing system.

The acetylenic alcohol in a preferred embodiment is methyl butynol, but may include methyl pentynol, hexynol, ethyl octynol, propargyl alcohol, benzylbutynol, ethynylcyclohexanol, and the like. The acetylenic alcohol may be present in the amount of from 0% to 5% by weight in the alcohol acidizing system.

The acetylenic diol in a preferred embodiment is an alkoxylated acetylenic diol such as is found in Surfynol® 2502 supplied by Air Products and Chemicals, Inc. of Allentown, Pa. Other diols may include Surfynol® CT-211, Surfynol® CT-221, Surfynol® DF-110D Defoamer, and Dynol™ 604, all supplied by Air Products and Chemicals, Inc. Other suitable diols may be used. The acetylenic diol may be present in the amount of from 0% to 5% by weight in the alcohol acidizing system.

An aqueous acid in the acidizing system may include an amount of 1 wt % to 36 wt % of pure acid in the acidizing system. If the aqueous acid is 15% hydrochloric acid, the aqueous acid may be present in the amount of from 50% to 99% by weight in the alcohol acidizing system.

With 50% by weight 15% hydrochloric acid, the acidizing system may contain from 25% to 49% by weight methanol, 0% to 20% by weight water, 0% to 5% by weight methyl butynol, and 0% to 5% by weight Surfynol® 2502, Surfynol® DF-11-D Defoamer, Surfynol® CT-211, Surfynol® CT-221 or Dynol™ 604. Other combinations yielding similar separation/effervescence times may be achieved within the parameters previously described, and as set out in the examples below.

With 75% by weight 15% hydrochloric acid, the acidizing system may contain 20% to 25% by weight methanol, 0% to 5% by weight methyl butynol, and 0% to 5% by weight Surfynol® 2502. Other combinations yielding similar separation/effervescence times may be achieved within the parameters previously described, and as set out in the examples below.

With 96% by weight 15% hydrochloric acid, the acidizing system may contain 4% methyl butynol. Other combinations yielding similar separation/effervescence times may be achieved within the parameters previously described, and as set out in the examples below.

Example: A scale sample was prepared by adding 15 g of heavy oil (density=985 kg/m3) to calcium carbonate (15 g). The scale sample was mixed thoroughly and allowed to age overnight. The scale sample was then weighed out to 4 g sizes and added to a 100 ml solution (listed below) and the reactions were observed. A solution including a ketone and an ester alcohol is included for reference.

| Alcohol | Solvent | Chemical | Chemical | Acid | Observations |
|---|---|---|---|---|---|
| | | | | 15% HCl | No oil separation, no |
| | | | | (100%) | effervescence |
| Methanol | Water 17.5% | Surfynol ® | Methyl Butynol (4%) | 15% HCl | Complete oil separation/ |
| (27.5%) | | 2502 (1%) | | (50%) | effervescence in 2.41 mins |
| Methanol | Water 17.5% | | Methyl Butynol (5%) | 15% HCl | Complete oil separation/ |
| (27.5%) | | | | (50%) | effervescence in 5.48 mins |
| Methanol | | | Methyl Butynol (5%) | 15% HCl | Complete oilseparation/ |
| (20%) | | | | (75%) | effervescence in 2.57 mins |
| Methanol | | Surfynol ® | Methyl Butynol (4%) | 15% HCl | Complete oil separation/ |
| (20%) | | 2502 (1%) | | (75%) | effervescence in 3.00 mins |
| Methanol | | | | 15% HCl | Complete oil separation/ |
| (25%) | | | | (75%) | effervescence in 20 mins |
| Methanol | Methyl acetate | | MEK (25%) | 15% HCl | Complete oil separation/ |
| (12.5%) | (12.5%) | | | (50%) | effervescence in 2.46 mins |
| Methanol | | | Dynol TM 604 (1%) | 15% HCl | Complete oil separation/ |
| (49%) | | | | (50%) | effervescence in 4.24 mins |
| Methanol | Water 19% | Surfynol ® | | 15% HCl | Complete oil separation/ |
| (29%) | | 2502 (2%) | | (50%) | effervescence in 3.39 mins |
| Methanol | | | Methyl Butynol (4%) | 15% HCl | Complete oil separation/ |
| (46%) | | | | (50%) | effervescence in 4.12 mins |
| | | | Methyl Butynol (4%) | 15% HCl | Complete oil separation/ |
| | | | | (96%) | effervescence in 2.08 mins |
| Methanol | | | Surfynol ® | 15% HCl | Complete oil separation/ |
| (48%) | | | DeFoamer 110D (2%) | (50%) | effervescence in 6.06 mins |
| Methanol | | | Surfynol ® CT- | 15% HCl | Complete oil separation/ |
| (48%) | | | 211 (2%) | (50%) | effervescence in 7.09 mins |
| Methanol | | | Surfynol ® CT- | 15% HCl | Complete oil separation/ |
| (48%) | | | 221 (2%) | (50%) | effervescence in 14.15 mins |

Immaterial modifications may be made to the invention described here, without departing from the invention as defined by the claims.

What is claimed is:

1. An alcohol acidizing composition for treating a well to increase the production of desired materials therefrom, the alchohol acidizing composition comprising: an aqueous acid solution including an aqueous acid and, based on the total weight of the aqueous acid solution, at least 1% by weight of at least one of an acetylenic alcohol, an acetylenic diol, and an alkyl alcohol.

2. The alcohol acidizing composition of claim 1 in which the aqueous acid comprises hydrochloric acid present in the amount of between 1% and 36% by weight of the alcohol acidizing composition.

3. The alcohol acidizing composition of claim 1 in which the acetylenic alcohol is present in the amount of between 0% and 5% by weight of the alcohol acidizing composition.

4. The alcohol acidizing composition of claim 1 in which the acetylenic diol is present in the amount of between 0% and 5% by weight of the alcohol acidizing composition.

5. The alcohol acidizing composition of claim 1 in which the alkyl alcohol is present in the amount of between 0% and 49% by weight of the alcohol acidizing composition.

6. The alcohol acidizing composition of claim 1 in which the alkyl alcohol is one or more of methyl alcohol, ethyl alcohol, and iso-propanol.

7. The alcohol acidizing composition of claim 1 in which the acetylenic alcohol is one or more of methyl butynol, methyl pentynol, hexynol, ethyl octynol, propargyl alcohol, benzylbutynol, and ethynylcyclohexanol.

8. The alcohol acidizing composition of claim 1 in which the acetylenic diol comprises an alkoxylated acetylenic diol.

9. The alcohol acidizing composition of claim 1 in which the alkyl alcohol is present in the amount of between 20% and 25% by weight, the acetylenic alcohol is present in the amount of between 0% and 5% by weight, and the acetylenic diol is present in the amount of between 0% and 5% by weight of the alcohol acidizing composition.

10. The alcohol acidizing composition of claim 1 in which the alkyl alcohol is present in the amount of between 25% and 49% by weight, the acetylenic alcohol is present in the amount of between 0% and 5% by weight, the acetylenic diol is present in the amount of between 0% and 5% by weight, and water is present in the amount between 0% and 20% by weight of the alcohol acidizing composition.

11. The alcohol acidizing composition of claim 1 in which the acetylenic alcohol is present in the amount of between 1% and 5% by weight of the alcohol acidizing composition.

12. A method of treating a well comprising injecting into the well an alcohol acidizing composition of claim 1.

13. The alcohol acidizing composition of claim 1 for use in the treatment of an oil or gas well.
